(19) United States
(12) Patent Application Publication
(10) Pub. No.: US 2024/0391039 A1
(43) Pub. Date: Nov. 28, 2024

(54) SPHERICAL BIT AND FASTENER DESIGN

(71) Applicant: Rockwell Automation Technologies, Inc., Mayfield Heights, OH (US)

(72) Inventor: Wesley R. Salverson, Milwaukee, WI (US)

(21) Appl. No.: 18/322,311

(22) Filed: May 23, 2023

(51) Int. Cl. B23P 19/06; B25J 11/00; F16B 23/00

(52) U.S. Cl. CPC B23P 19/06; B25J 11/005; F16B 23/0046

(57) ABSTRACT

Various embodiments of the present technology generally relate to an automation system that allows for ease of opening and closing, latching or unlatching, or switching on or off components using a spherical bit and corresponding receptacle that allow for a degree of misalignment not previously available. Accordingly, automated maintenance or other tasks may be performed with more speed and efficiency than previously available. Specifically, the spherical bit includes a spherical portion having teeth circumferentially disposed across. A corresponding receptacle includes a spherical void having grooves that correspond to the teeth of the spherical bit. The size and shape of the receptacle and bit as well as the location, size, shape, and number of teeth and corresponding grooves allow for a misalignment of up to 24 degrees in any direction.

### TECHNICAL BACKGROUND

Various implementations disclosed herein relate to rotatable bit implements configured to achieve coupling with devices capable of being rotated by the implements at degrees of misalignment, and more specifically to automation machines having the rotatable bit implements that achieve coupling despite misalignment.

### BACKGROUND

Automated machines are widely utilized in facilities in various commercial settings. Automated machines may perform functions ranging from moving items from place to place on a facility floor to more complex functions including those performed by robotic components. In many cases, task automation improves consistency, reliability, and speed. In some scenarios, task automation may improve safety.

In some environments, an automated machine may include and employ various types of rotatable bits or other implements for rotating fastening devices positioned on equipment in the facility. In many cases, the bits may resemble conventional hand tool bits like screwdrivers for coupling with a corresponding fastening device. For example, cabinets may be locked, closed, or fastened with a fastening device (e.g., a screw). Accordingly, a bit with a corresponding coupling may be used to unfasten the cabinet. Known bits and corresponding fastening devices typically require little or no misalignment between the bit and the fastening device to effectively rotate the fastening device. The alignment required may reduce the effectiveness or operational efficiency of automated machines used to rotate the fastening devices. Furthermore, in cases where this requirement is unachievable by automated machines in hazardous facility environments, requiring human personnel to perform the operations manually is undesirable.

Accordingly, bits and corresponding fastening devices that can withstand misalignment are needed.

### SUMMARY

Various embodiments of the present technology generally relate to an automation system for use in a facility, for example. The automation system may be configured to open or close an MCC or any other cabinet or component having a lock or fastener. The lock or fastener is configured to be fastened and unfastened using a spherical bit as described in more detail herein. Specifically, the spherical bit may have a spherical portion at the end of the bit that includes teeth that extend from the tip of the spherical portion to the edge of the spherical portion. The fastener includes a corresponding spherical void and grooves that couple with the spherical bit such that the grooves of the void couple with the teeth of the spherical bit. Accordingly, when the spherical bit is rotated, the fastening device also rotates.

One general aspect may be an automation system may include an automated machine. The automated machine may be embodied in a robot or an automated guided vehicle. The automated machine may include a robotic arm coupled to a controller and a driver. The driver may be coupled to a spherical bit. The controller may include instructions that, upon execution by one or more processors of the controller, cause the robotic arm to autonomously move to align and couple the spherical bit with a receptacle of a fastening device, and the driver to spin on an axis to rotate the fastening device. The system may also include the spherical bit, which may include a first bit end and a second bit end, where the first bit end is coupled to the driver. The second bit end may include a spherical portion that couples with the receptacle of the fastening device. The spherical portion may include teeth disposed circumferentially on and extending radially over the spherical portion. Each of the teeth may include a first end proximate to a tip of the spherical portion and a second end proximate to an edge of the spherical portion.

Implementations may include one or more of the following features. Optionally, the industrial automation system may include the fastening device, where the fastening device may include a body having a coupling end and a fastening end. The coupling end may include the receptacle, the receptacle may include a spherical void formed in the body at the coupling end. The spherical void may include a plurality of grooves circumferentially spaced on and extending radially into the spherical void such that when coupled, each of the plurality of teeth of the spherical bit fit into one of the plurality of grooves of the fastening device. Optionally, the industrial automation system includes a motor control cabinet, and the fastening device fastens the door of the motor control cabinet.

Optionally, the second end of the teeth are equidistantly spaced about the edge of the spherical portion. Optionally, each of the teeth is tapered to a point at the first end. Optionally, the tip of the spherical portion may include an arcuate surface including the point of the first end of each of the teeth, and a distance from a center point of the spherical portion to the point and any other point on the arcuate surface is less than a radius of curvature of the spherical portion. Optionally, the spherical portion of the spherical bit further may include grooves positioned between each of the teeth and extending radially into the spherical portion. Optionally, each of the grooves is tapered in a direction of the edge toward the tip. Optionally, at least a portion of a surface of each of the grooves is convexly arcuate. Optionally, a radius of curvature of the spherical portion allows for misalignment of up to twenty-four (24) degrees off an axis of the fastening device. Implementations of the described techniques may include hardware, a method or process, or computer software on a computer-accessible medium. For example, the spherical bit is hardware and the instructions that are executed by the controller are software.

Another general aspect includes a spherical bit for rotating a fastening device. The spherical bit may extend along an axis from the first bit end to the second bit end. The first bit end may include a spherical portion centered on the axis such that the axis extends through a tip of the spherical portion. The spherical portion may include teeth disposed circumferentially on and extending radially over the spherical portion, and each of the teeth may include a first end proximate to the tip of the spherical portion and a second end proximate to an edge of the spherical portion.

Implementations may include one or more of the following features. Optionally, the second end of the teeth are equidistantly spaced about the edge of the spherical portion. Optionally, at least a portion of a radially outward surface of the teeth is concavely arcuate. Optionally, each of the teeth is tapered to a point at the first end. Optionally, the tip of the spherical portion may include an arcuate surface including the point of the first end of each of the teeth, and a distance from the tip of the spherical portion to the point and any other point on the arcuate surface is less than a radius of curvature of the spherical portion. Optionally, the spherical portion of the spherical bit further may include grooves positioned between each of the teeth and extending radially into the spherical portion. Optionally, the grooves are tapered in a direction of the edge toward the tip. Optionally, at least a portion of a surface of the grooves is convexly arcuate.

Another general aspect includes a fastening device having a body with a fastening end and a coupling end. The fastening device may extend along an axis from the fastening end to the coupling end. The coupling end may include a receptacle, and the receptacle may include a spherical void formed in the body at the coupling end. The spherical void may include grooves circumferentially spaced on and extending radially into the spherical void. Each of the grooves may include a first end proximate to an edge of the spherical void and a second end proximate to a bottom center of the spherical void. Optionally, the first end of the grooves are equidistantly spaced about an edge of the spherical void.

### BRIEF DESCRIPTION OF THE DRAWINGS

Many aspects of the disclosure can be better understood with reference to the following drawings. The components in the drawings are not necessarily drawn to scale. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIGS. 1A and 1B illustrate two views of an example spherical bit, according to some embodiments.

FIG. 2 illustrates a view of an example fastening device, according to some embodiments.

FIG. 3 illustrates an example automation system incorporating the spherical bit and fastening device, according to some embodiments.

FIG. 4 illustrates another example spherical bit, according to some embodiments.

FIG. 5 illustrates a perspective view of a spherical portion for spherical bits, according to some embodiments.

FIG. 6 illustrates details of the teeth of an example spherical bit, according to some embodiments.

FIG. 7 illustrates a perspective view of another spherical portion for spherical bits, according to some embodiments.

FIG. 8 illustrates another example of a spherical bit, according to some embodiments.

FIG. 9 illustrates yet another example of a spherical bit, according to some embodiments.

FIG. 10 illustrates yet another example of a spherical bit, according to some embodiments.

FIG. 11 illustrates yet another example of a spherical bit, according to some embodiments.

FIG. 12 illustrates a head of a fastening device, according to some embodiments.

FIG. 13 illustrates a side view of a head of a fastening device, according to some embodiments.

FIG. 14 illustrates a top-down view of a head of a fastening device, according to some embodiments.

FIG. 15 illustrates a view of a system incorporating a spherical bit and corresponding fastening device, according to some embodiments.

FIG. 16 illustrates an example of a computing system, according to some embodiments.

The drawings have not necessarily been drawn to scale. Similarly, some components or operations may not be separated into different blocks or combined into a single block for the purposes of discussion of some of the embodiments of the present technology. Moreover, while the technology is amendable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

As discussed in the background, some industrial automation environments utilize automated systems for opening and closing cabinets, locking and unlocking components, and the like. In some cases, working within the industrial automation environment is dangerous to people. For example, high voltages and other aspects of the environment may pose dangers to humans. As a specific example, a motor control cabinet (MCC) may include high voltage devices and other components that pose such a danger that any person opening the MCC must wear a bomb-rated suit. Accordingly, automated machinery that can access and perform maintenance on the MCC may be a valuable improvement to the industrial automation environment. However, to open or close (e.g., fasten or unfasten, lock or unlock) components or cabinets like the MCC, the bit that couples with the fastening device must often be fairly precisely aligned. To improve the ability of automated systems to fasten and unfasten the fastening devices, a spherical bit and corresponding fastening device are disclosed that allow for substantial misalignment.

Various embodiments of the present technology generally relate to an automation system for use in a facility, for example. The automation system may include an automated machine such as a robot or an automated guided vehicle. The automated machine may include an arm coupled to a driver and the spherical bit. The arm is also coupled to a controller that is capable of autonomously moving the arm to align the spherical bit with a receptacle of a fastener device. The controller may also cause the driver to spin on an axis to rotate the fastening device. In some examples, the driver may include an electric motor and associated driver circuitry.

The automation system may include one or more motor control cabinets situated in a facility. Manual human performed tasks in a motor control cabinet may be hazardous due to high voltages and exposed conductors. Access to the interior of a motor control cabinet may be controlled using the fastening device according to the present technology. An automated machine having the spherical bit according to the present technology may be employed to alternately lock and unlock (fasten and unfasten) cabinet doors of the motor control cabinets. The automated machine may also utilize the spherical bit to perform operations within the interior of the cabinet after accessing it such as, for example, operation of circuit breakers. In some examples, a circuit breaker may include a rotatable device having a receptacle that couples to the spherical bit. In this way, the circuit breaker may be operated by the spherical bit rotating the rotatable device of the circuit breaker.

Advantageously, the spherical bit may couple with the receptacle of the rotatable or fastening device despite misalignment of up to twenty four (24) degrees off an axis of the fastening device. The ability to correct alignment for rotating the rotatable device despite initial misalignment provides the ability to use automated machines in some previously unusable scenarios and provides improved speed of use because despite initial misalignment, the coupling is completed and misalignment is corrected.

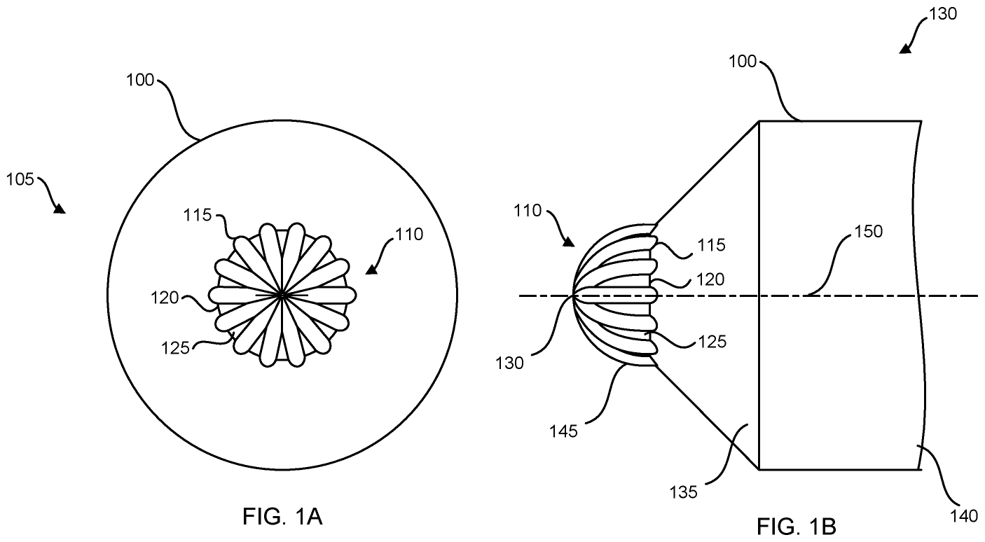

Now referring to the Figures, FIG. 1A illustrates a first view 105 of a spherical bit 100 (also called S-bit 100 throughout). FIG. 1B illustrates a second view 155 of a portion of spherical bit 100. Spherical bit 100 includes a body 135 that may be cylindrical in shape and may taper from a shaft end 140 to a coupling end 145 that includes the spherical portion 110 of the body 135.

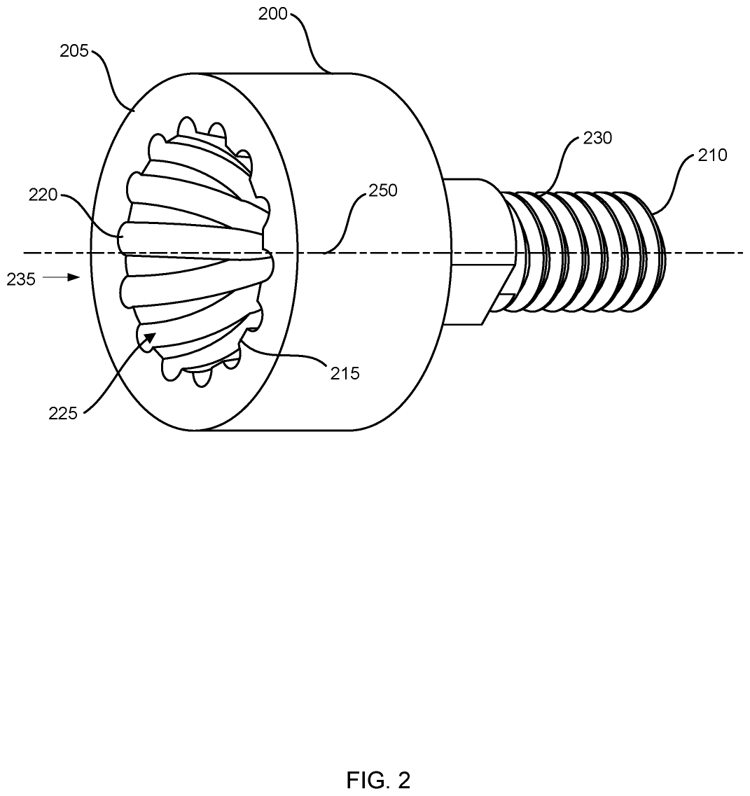

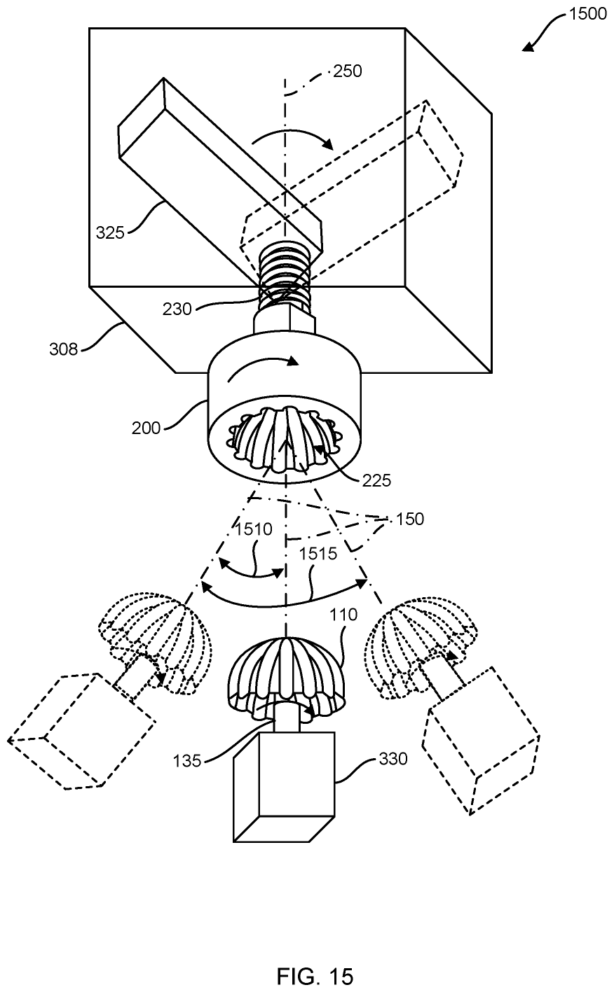

The spherical bit includes the spherical portion 110, which may also be described as a hemispherical portion, at least partially spherical, at least partially hemispherical, or the like. In some embodiments and as shown in FIGS. 1A and 1B, the spherical portion 110 is a hemisphere, though other portions of the sphere may be implemented. The spherical portion 110 may have a radius that allows for misalignment of up to twenty-four (24) degrees of misalignment off an axis of a fastening device (e.g., fastening device 200 as described with respect to FIG. 2) as described in more detail with respect to FIG. 15. The size of the spherical portion may be any size suitable for and selected depending on the use of spherical bit 100. For example, a radius of spherical portion 110 may be 0.25 inches, 0.5 inches, 1 inch, 2 inches, or any other size. The embodiment shown in FIGS. 1A and 1B includes a radius of 0.25 inches.

The spherical portion 110 may have teeth 115 disposed on the spherical portion 110 that extend or run from a tip 130 of the spherical portion 110 to an edge 120 of the spherical portion 110. Between each of the teeth 115 are grooves 125. Grooves 125 may be cut out to form teeth 115, or teeth 115 may be disposed to form grooves 125, or any combination thereof. As shown in FIGS. 1A and 1B, there may be fourteen (14) teeth circumferentially disposed on the spherical portion 110 and extending radially over spherical portion 110 from tip 130 to edge 120. However, more or fewer teeth may be used while allowing for correction of misalignment as well as withstanding the force of rotation without stripping teeth 115. Teeth 115 may be any size suitable for situation on spherical portion 110. The embodiment shown in FIGS. 1A and 1B include teeth 115 having a width of 0.0625 inches.

Teeth 115 may join together at tip 130 and each extend radially over spherical portion 110 to edge 120. Teeth 115 may be equidistantly spaced such that there is an equal distance between each of teeth 115 at edge 120.

The spherical bit 100 may be made from any suitable material including plastic, metal, or the like. Axis 150 extends through a center of spherical bit 100 and is used throughout these figures to show the axial direction consistently within each figure.

FIG. 2 illustrates a view of a fastening device 200. The fastening device 200 corresponds to the spherical bit 100 in that the spherical portion 110 of the spherical bit 100 couples with the receptacle 225 of the fastening device 200 so that rotation of the spherical bit 100 rotates the fastening device 200.

Fastening device 200 includes a receptacle end 205 that includes the receptacle 225. Receptacle 225 includes a spherical void 235 formed in the body of fastening device 200. The spherical void 235 may be a hemisphere as shown, or the spherical void 235 may be any portion of a sphere. The spherical void 235 may also be described as a hemispherical, at least partially spherical, at least partially hemispherical, or the like. The size of the spherical void 235 may be any size suitable for and selected depending on the use of fastening device 200. For example, a radius of the spherical void 235 may be 0.25 inches, 0.5 inches, 1 inch, 2 inches, or any other size. The embodiment shown in FIG. 2 includes a radius of 0.25 inches for spherical void 235.

Receptacle 225 includes grooves 220 formed in the spherical void 235 that are circumferentially spaced on and extending radially into the spherical void 235 from an edge 215 of the spherical void 235 to the bottom center of the spherical void 235. Receptacle 225 includes 14 grooves 220 to correspond with the number of teeth 115 of spherical bit 100 shown in FIGS. 1A and 1B. If more or fewer teeth 115 are included in spherical bit 100, a corresponding number of grooves 220 are formed in receptacle 225 and vice versa. Grooves 220 may be any size suitable for forming in the spherical void 235. The embodiment shown in FIG. 2 includes grooves 220 having a width of 0.0625 inches.

Fastening device 200 includes fastening end 210. As shown in FIG. 2, fastening end includes a screw design with threads 230 such that rotation of fastening device 200 in one direction tightens or fastens fastening device 200 and rotation in the other direction loosens or unfastens fastening device 200. While a fastening design is shown that resembles a screw or bolt, fastening end 210 of fastening device 200 may instead be, for example, a latch that may rotate 90 degrees to latch or unlatch. In some embodiments, fastening end 210 may instead be a switch that when rotated in one direction turns on and in the other direction turns off a component such as a circuit breaker, a light, or any other device having an on and off functionality.

Fastening device 200 may be made from any suitable material including, for example, metal, plastic, or the like.

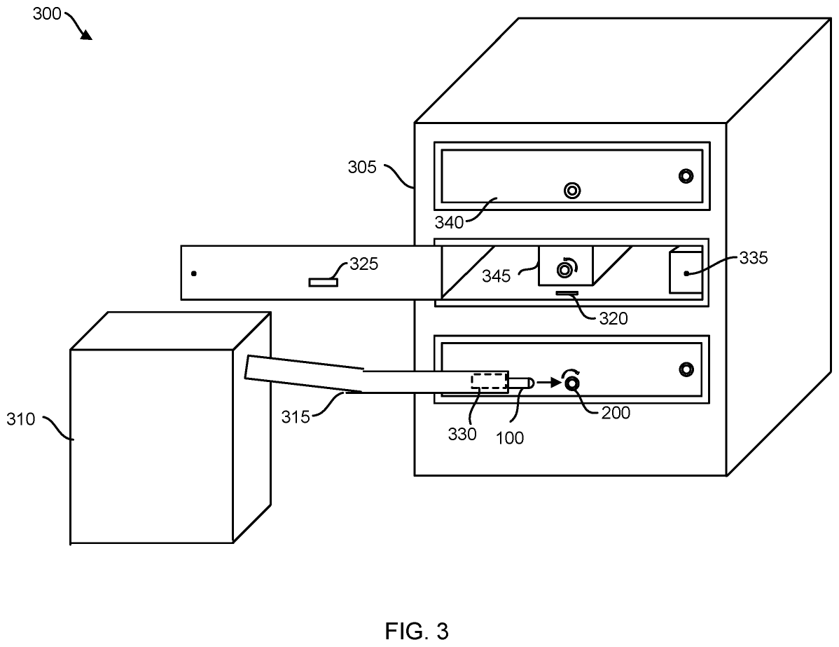

FIG. 3 illustrates an example industrial automation system 300 including spherical bit 100 and corresponding fastening devices 200 according to some embodiments of the disclosure. Industrial automation system 300 may include an automated machine 310 and an industrial cabinet 305 such as a motor control cabinet (MCC).

Automated machine 310 may include an arm 315, a driver 330, spherical bit 100, and a controller (not shown). Automated machine 310 may be, or may include, an automated guided vehicle (AGV). Automated machine 310 may include wheels to move about the industrial automation environment in some embodiments or may be stationary.

Automated machine 310 includes an actuatable arm 315 extending outward from the body of automated machine 310. Arm 315 may include and be coupled with circuitry within automated machine 310 so that arm 315 may be instructed to move. Driver 330 may be coupled to a distal end of arm 315 and may be coupled to circuitry within automated machine 310 such that driver 330 may be instructed to spin (i.e., rotate or turn). Spherical bit 100 may be coupled to driver 330 so that spherical bit 100 rotates when driver 330 rotates. In some embodiments, spherical bit 100 is detachably coupled to driver 330.

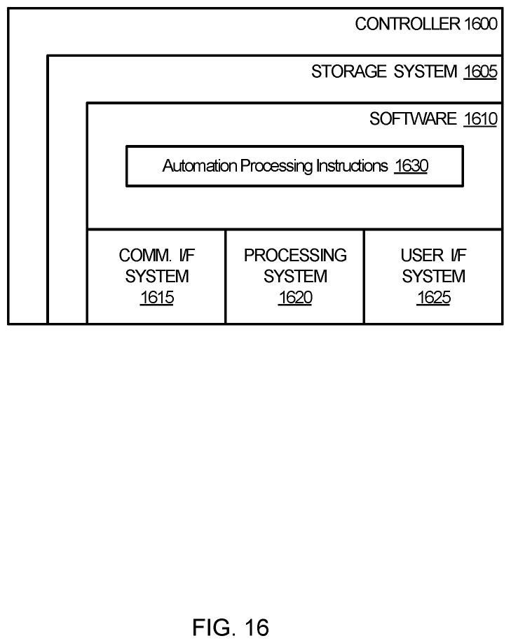

Automated machine 310 may include a controller within the body that may include at least one memory storage device that stores program instructions as software and/or firmware code. The controller may be a computing device with components and features as described for controller 1600 of FIG. 16. The memory storage device may include non-transitory computer readable storage media. The controller includes at least one processor that may execute the program instructions in the memory storage device to control automated machine 310. For example, the controller may cause arm 315 to autonomously move to align and couple spherical bit 100 with fastening device 200. Further, the controller may execute the program instructions to instruct driver 330 operably coupled to arm 315 and spherical bit 100 to spin on an axis to rotate or turn spherical bit 100, which in turn rotates fastening device 200 when fastening device 200 and spherical bit 100 are coupled.

Cabinet 305 may be, for example, a motor control cabinet (MCC). Cabinet 305 may include at least one drawer or opening having door 340 that may be, for example, a hinged door or sliding drawer to alternately enable and block access to the interior of cabinet 305. Inside cabinet 305, various electrical equipment may be situated for use in operations such as control of motors positioned in the facility. For example, and without limitation, one or more circuit breakers 345 may be positioned inside cabinet 305. Electrical systems and components like circuit breakers 345 may be operating at a high voltage and may include exposed live conductors like buses and the like. Accordingly, cabinet 305 may include locks using fastening device 200 or other implementations of fastening device 200 to provide a safe operating condition for the facility where access can be controlled as the need arises for maintenance activities, for example.

For operations in facilities that are potentially hazardous like maintenance and other tasks to be performed on cabinet 305, use of automated machine 310 may be advantageous for safety, efficiency, and other reasons. Among other potential useful functionalities, automated machine 310 may open and close (fasten and unfasten, latch and unlatch) doors 340 (or drawers) of cabinet 305 by rotating fastening devices 200 using spherical bit 100. The controller may instruct arm 315 to align spherical bit 100 with fastening device 200 and couple spherical bit 100 with fastening device 200. The controller may then instruct driver 330 to rotate to fasten or unfasten fastening device 200. For example, the controller may instruct driver 330 (e.g., electric motor) capable of turning spherical bit 100 alternately in clockwise (CW) and counterclockwise (CCW) directions. As described in greater detail throughout, the coupling end of spherical bit 100 may include a spherical portion 110. The spherical portion 110 is designed to mate in a complimentary structural manner with a receptacle 225 including spherical void 235 of the fastening device 200 in a male-female configuration.

In some embodiments, Door 340 of cabinet 305 may include a locking mechanism having a latch piece 325 operably coupled through a hole in door 340 to a receptacle end of fastening device 200. With door 340 in a closed position, latch piece 325 may be positioned with a distal end situated in slot 320 to latch door 340 closed. To unlatch door 340, automated machine 310 may move arm 315 to align and couple spherical bit 100 with fastening device 200 and instruct driver 330 to rotate spherical bit 100, which causes fastening device 200 to rotate and unlatch door 340. Stated differently, automated machine 310 may maneuver itself and arm 315 to position the spherical portion 110 of spherical bit 100 into the spherical void 235 of receptacle 225 of fastening device 200, thereby effectuating the male-female coupling therebetween. Next, a controller of automated machine 310 may cause driver 330 to rotate spherical bit 100, thereby causing fastening device 200, as well as latch piece 325, to rotate. The rotation further causes latch piece 325 to exit slot 320, thereby enabling door 340 to be opened, as by additional features and movement routines of the arm 315 or other components of automated machine 310.

In some embodiments, with door 340 in the opened position, a portion of circuit breaker 345 is accessible. Circuit breaker 345 may include rotatable functional components operably coupled to additional instances of fastening device 200. For example, and without limitation, a trip mechanism of circuit breaker 345 may be operably coupled to fastening device 200. Tripping of circuit breaker 345 may cause fastening device 200 to rotate to a tripped position and resetting circuit breaker 345 may involve rotating fastening device 200 in the opposite direction. For example, automated machine 310 may then maneuver itself and arm 315 to position the spherical portion 110 of spherical bit 100 into the spherical void 235 of receptacle 225 of fastening device 200 coupled to the trip mechanism of circuit breaker 345. The controller of automated machine 310 may cause driver 330 to rotate the spherical bit 100, thereby causing the fastening device 200, as well as the trip mechanism, to rotate. The rotation, depending on direction of the rotation, may trip circuit breaker 345 or reset circuit breaker 345 to a reset (i.e., untripped) state. Accordingly, automated machine 310 may use spherical bit 100 to fasten and unfasten, lock and unlock, and generally rotate any fastening device 200 having a corresponding receptacle 225 to accomplish tasks such as locking and unlocking cabinet 305 doors 340, tripping and resetting circuit breakers 345, and the like.

Further, in some embodiments fastening device 200 includes a shaft having threads 230 that protrudes through a hole in door 340 of cabinet 305. In such examples, threads 230 may align with a threaded bore 335 situated inside of cabinet 305. Rotation of fastening device 200 by the spherical bit 100 may unscrew the threads 230 of fastening device 200 from the threaded bore 335 to thereby unfasten door 340. Automated machine 310 may open door 340 and perform maintenance operations, for example. Upon completion of tasks within cabinet 305, automated machine 310 may fasten fastening device 200 by causing arm 315 to align spherical bit 100 with fastening device 200 and causing driver 330 to rotate spherical bit 100 and thereby fastening device 200 in a fastening direction.

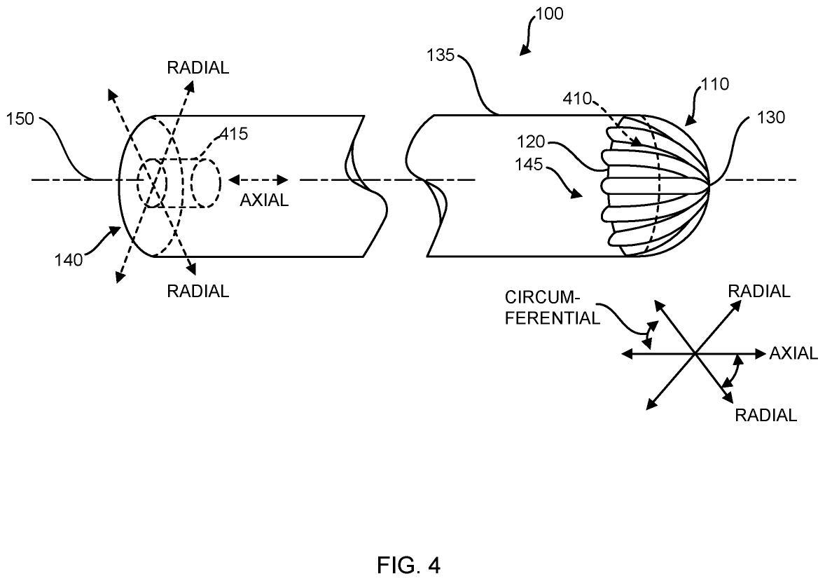

FIG. 4 illustrates perspective view of an example of a spherical bit 100 for rotating a fastening device 200. Spherical bit 100, also referred to herein more succinctly as “S-bit,” may include a coupling end 145 and a shaft end 140 opposite the coupling end 145. In some embodiments, the S-bit 100 may include an elongate body 135 extending from the coupling end 145 to the shaft end 140. The S-bit 100 may extend axially along an axis 150 from the coupling end 145 to the shaft end 140′.

S-bit 100 may include spherical portion 110 (e.g., at least partially hemispherical portion) having tip 130. Spherical portion 110 is or includes the working end or coupling end of S-bit 100. Tip 130 may be centered on axis 150 such that axis 150 extends through tip 130 of the spherical portion 110. In this way, the spherical side of the spherical portion 110 extends axially out from the coupling end 145 of S-bit 100.

Spherical portion 110 may be formed into coupling end 145 of S-bit 100 by any suitable technique known, or to be known in the future, by persons having ordinary skill in the art. For instance, spherical portion 110 may be formed by machining, molding, extruding, grinding, stamping, carving, and/or reductive manufacturing techniques, which may be selected according to the particular material(s) of construction involved. In some embodiments, three-dimensional (3D) printing may be used to manufacture spherical bit 100.

In some embodiments, spherical portion 110 may be added onto the coupling end 145 of S-bit 100. For example, coupling end 145 of S-bit 100 may be formed or fabricated without initially including spherical portion 110. Spherical portion 110 may be formed onto or otherwise added to coupling end 145 of S-bit 100 by any suitable technique known, or to be known in the future, by persons having ordinary skill in the art. For example, spherical portion 110 may be formed onto coupling end 145 by welding, cementing, screwing, and similar techniques. Alternatively, or additionally, spherical portion 110 may be added onto coupling end 145 by 3D printing, powder bed sintering, and similar additive manufacturing techniques, which may be selected according to the particular material(s) of construction involved.

Spherical portion 110 may be situated, seated, or formed on coupling end 145 of spherical bit 100 such that edge 120 of spherical portion 110 defines a juncture between the arcuate surface(s) of spherical portion 110 and an at least partially planar region 410 of the spherical portion 110, where region 410 is coupled to coupling end 145, thereby extending coupling end 145 to include spherical portion 110.

In some embodiments, S-bit 100 may include one or more means 415 for coupling spherical bit 100 to a device or system (e.g., electric motor-based driver such as driver 330 of automated machine 310, or the like) capable of applying a torque to body 135 to cause S-bit 100 to rotate. Means 415 may include a cavity having an opening formed into body 135 at shaft end 140. In an example, this cavity may be cylindrical, square, or polyhedral (e.g., hexagonal) and may be shaped and dimensioned to receive a rotatable shaft (e.g., driver 330) capable of applying a torque to body 135. Various other embodiments having different configurations of the means 415 for coupling are described throughout this description.

Body 135 of S-bit 100 is shown as cylindrical in FIG. 4. The cylindrical shaft may have a diameter equal to, or approximately the same as (e.g., within +/−5%, or 2.5%, or 1%, or 0.1%, or 0.01%, or 0.001%) a diameter of region 410 as shown in FIG. 4. In some embodiments, body 135 may be tapered such that edge 120 of spherical portion 110 is the same or substantially the same diameter as body 135 at the connection but is tapered such that the shaft end 140 of body 135 is a larger diameter. Body 135 may have a length that is sufficient to enable S-bit 100 to be rotated manually by a user or by a machine (e.g., automated machine 310). Various other embodiments having different configurations of body 135 are described in further detail herein.

In other embodiments S-bit 100 may include spherical portion 110 without body 135 so that spherical portion 110 may be coupled to a shaft without use of body 135 and means 415 may instead be formed in and through region 410 of spherical portion 110. For example, body 135 may be couplable to spherical portion 110 at, or proximate to coupling end 145. In such examples, a single body 135 may be used with various S-bits 100 disclosed herein. The various S-bits 100 may be interchanged on one or more bodies 135 so that various sizes (e.g., diameters or heights) and/or particular features may be advantageously selected to be utilized depending on the job.

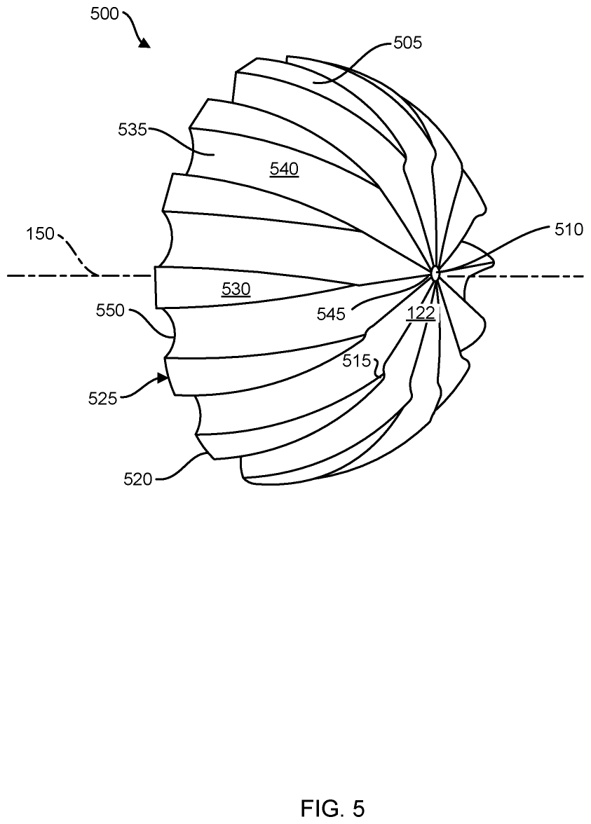

FIG. 5 illustrates a perspective view of an example of a spherical portion 500 for a spherical bit 100 according to some embodiments of the disclosure. Spherical portion 500 includes different features than spherical portion 110 and may be used in place of spherical portion 110 in some embodiments. Spherical portion 500 may include teeth 505. Teeth 505 may be similar to teeth 115 in that they are formed, positioned, or disposed similarly on spherical portion 500 as described with respect to teeth 115, there may be a similar number of teeth 505 as described with respect to teeth 115, and teeth 505 may be formed of the same materials and with the same processes described with respect to teeth 115. The teeth 505 may be disposed and spaced circumferentially on and extend radially over spherical portion 500. Teeth 505 may include a first end 515 positioned at, or proximate to, the tip 510 of spherical portion 500. Teeth 505 may include a second end 520 positioned at, or proximate to, the edge 525 of spherical portion 500. Radially outward portions of the teeth 505 may define surfaces 530, with respective teeth 505 extending from the first end 515 at, or proximate to, tip 510 to the second end 520 at, or proximate to, the edge 525. In some embodiments, at least a portion of the radially outward surface 530 may define a symmetric shard shape that curves and tapers from the second end 520 toward the first end 515.

Spherical portion 500 may include grooves 535 positioned between teeth 505. Teeth 505 may be formed onto spherical portion 500 (e.g., by an additive manufacturing technique) and grooves 535 may be thus naturally formed as a result of forming teeth 505 in that manner. In another example, grooves 535 may be formed into spherical portion 500 (e.g., by a reductive manufacturing technique) and teeth 505 may thus be naturally formed as a result. In either case, grooves 535 may extend radially into spherical portion 500.

Radially outward portions of the grooves 535 may define surfaces 540, with respective grooves 535 extending from a first end 545 at, or proximate to, tip 510 to a second end 550 at, or proximate to, the edge 525. In some embodiments, at least a portion of a radially outward surface 540 of grooves 535 may be convexly arcuate. In the example shown, surface 540 of each of the grooves 535 is convexly arcuate.

Design features of the spherical portion 500 may provide advantageous practical and technical benefits to users such as facilitating mating fitting with a complementary rotatable device (e.g., fastening device 200). In addition to the shape of the spherical portion 500 (and spherical portion 110 as described with respect to FIGS. 1A, 1B, and 4), such design features may enable mating and subsequent rotation under torque with some degree of axial misalignment as between the spherical portion 500 and the mating rotatable device.

To these advantageous ends, in some embodiments, teeth 505 may be circumferentially disposed on the spherical portion 500 with equidistant spacing between respective first ends 515 of each tooth 505. Further respective second ends 520 may be equidistantly spaced about edge 525. In some embodiments at least one tooth 505 may not have equidistant spacing with respect to at least one other tooth 505. In some embodiments, at least one tooth 505 may be tapered in an edge 525-to-tip 510 direction. In other embodiments, at least one tooth 505 may be tapered in a tip 510-to-edge 525 direction.

In some embodiments, grooves 535 may be circumferentially disposed on spherical portion 500 with equidistant spacing between respective first ends 545 of each groove 535. In other embodiments, at least one groove 535 first end 545 may not have equidistant spacing with respect to at least one other groove 535 first end 545. In some embodiments, grooves 535 may be circumferentially disposed on spherical portion 500 with equidistant spacing between respective second ends 550 of each groove 535. In other embodiments, at least one groove 535 second end 550 may not have equidistant spacing with respect to at least one other groove 535 second end 550. In some embodiments, at least one groove 535 may be tapered in a tip 510-to-edge 525 direction. In other embodiments, at least one groove 535 may be tapered in an edge 525-to-tip 510 direction.

The first end 515 of teeth 505 may form points. A surface 122 including the points of the first end 515 of teeth 505 and tip 510 may be formed. Surface 122 may be circular with a circumference defined by points of the first end 515 of each of the teeth 505. The surface 122 may be planar or arcuate in some embodiments.

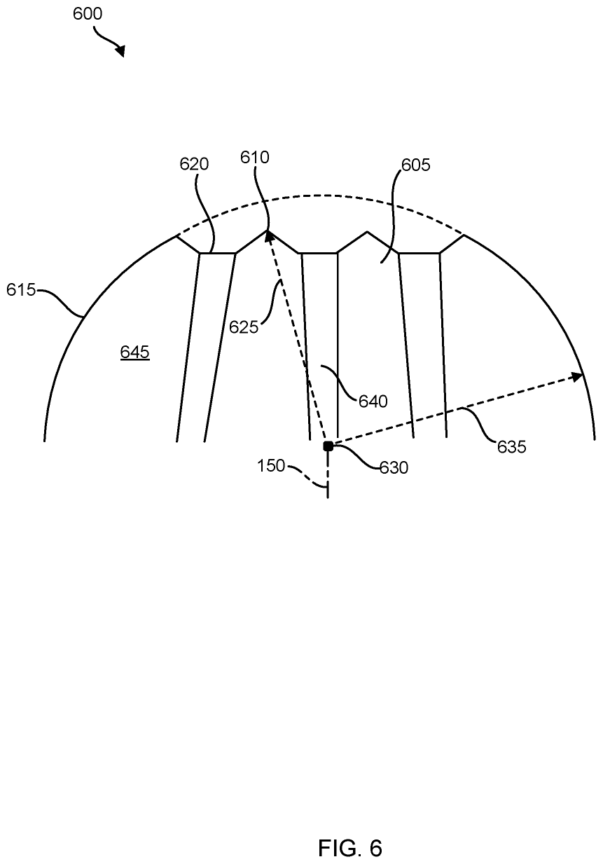

FIG. 6 illustrates a side view of aspects of an example portion 600 of a spherical portion (e.g., spherical portion 110 or spherical portion 500) of a spherical bit (e.g., spherical bit 100). Portion 600 includes teeth 605 that are substantially similar to teeth 505 of FIG. 5 and grooves 640 that are substantially similar to grooves 535 of FIG. 5. Teeth 605 may be tapered to a point 610 at the first end. Instead of, or in addition to, teeth 605 being tapered to the point 610, in some embodiments, spherical portion 615 may include, or be embodied in, an at least partially arcuate or planar surface 620. Teeth 605 may be tapered to, and terminate at, the point 610, and the surface 620 may include the points 610.

Portion 600 includes the at least partially arcuate or planar surface 620. As such, spherical portion 615 is only partially spherical. In some embodiments, a distance 625 from a center point 630 of the spherical portion 615 (e.g., of region 410) to the point 610 and also to at least one other point on the at least partially arcuate or planar surface 620 may be less than a radius of curvature 635 of the spherical portion 615 (e.g., as measured from center point 630 to surfaces 645 of teeth 605).

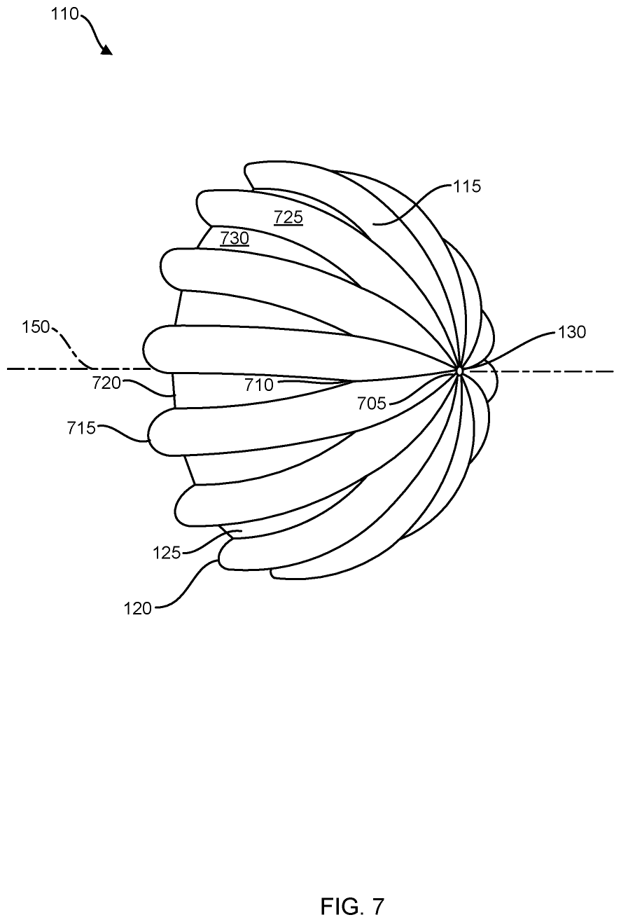

FIG. 7 illustrates a perspective view of another example of a spherical portion 110 for spherical bits 100 according to some embodiments of the disclosure. Spherical portion 110 is substantially the same as spherical portion 110 described with respect to FIGS. 1A, 1B, and 4. In some embodiments, first ends 705 of each tooth 115 may terminate at tip 130 at a single point. At least a portion of the surface 725 of teeth 115 may be concavely arcuate. In some embodiments, the entire surface 725 of teeth 115 is concavely arcuate, and at least a portion of the radially outward surface 730 of grooves 125 may define a symmetric shard shape that curves and tapers from the second end 720 toward the first end 710.

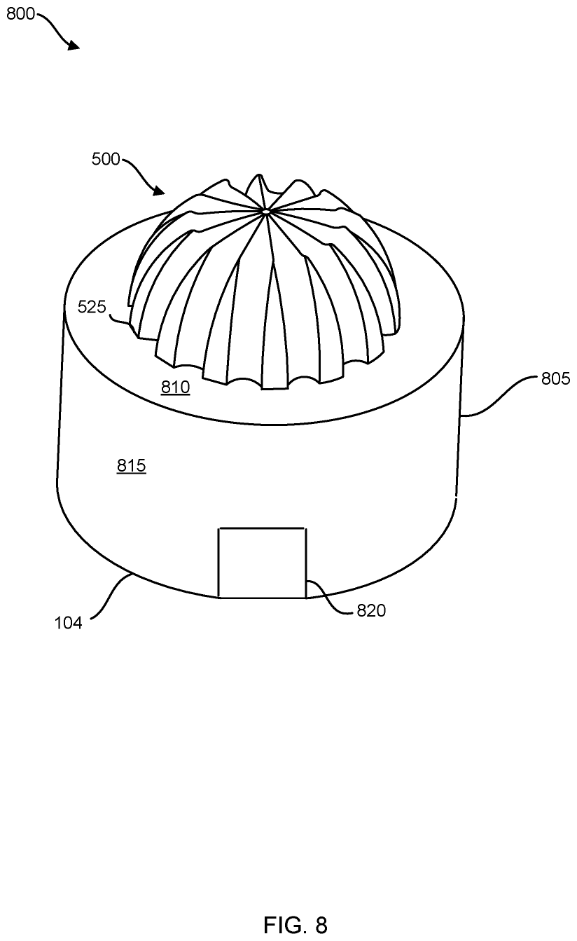

FIG. 8 illustrates a perspective view of another example of an S-bit 800 including spherical portion 500 and body 805. In this example, body 805 is cylindrical and has a diameter wider than the diameter of spherical portion 500. Spherical portion 500 (which is the same as that described with respect to FIGS. 5 and 6) is seated on, formed on, or coupled to body 805. Spherical portion 500 is centered within, and is thus concentric with, a circular region 810 of body 805, thereby resulting in a ledge or ledge-like structure that extends from the edge 525 to the juncture of the region 810 and a radially outward surface 815 of body 805. Also shown in FIG. 6 is another example of a means 820 for coupling the spherical bit 800 to a device or system capable of applying a torque to body 805 to cause S-bit 800 to rotate. Means 820 for coupling is or includes a flat planar region that is formed as, for example and without limitation, into a portion of surface 815 of body 805.

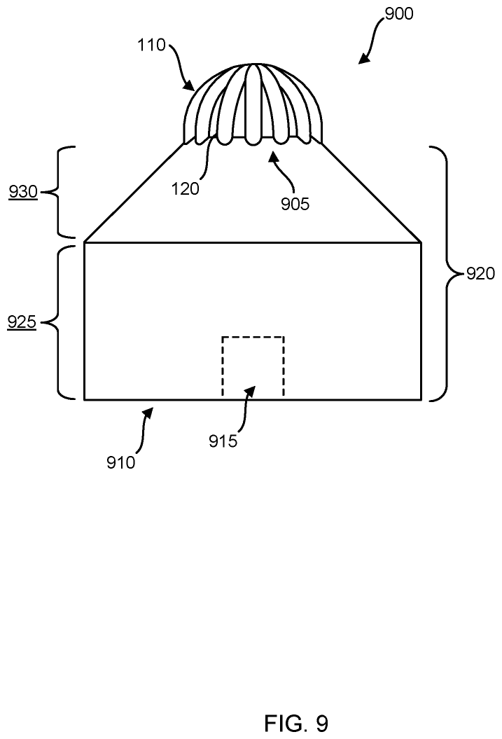

FIG. 9 illustrates a side view of another example of an S-bit 900, according to some embodiments of the disclosure. Body 920 may include a cylindrical portion 925 and a frustoconical portion 930. A diameter of the cylindrical portion 925 at the second end 910 is greater than a diameter of the edge 120 of the spherical portion 110. The frustoconical portion 930 extends axially away from the cylindrical portion 925 and includes the first end 905. In the illustrated example, the edge 120 of the spherical portion 110 has the same diameter as the first end 905. S-bit 900 further includes means 915 for coupling to a device or system capable of applying a torque to body 920 to cause S-bit 900 to rotate.

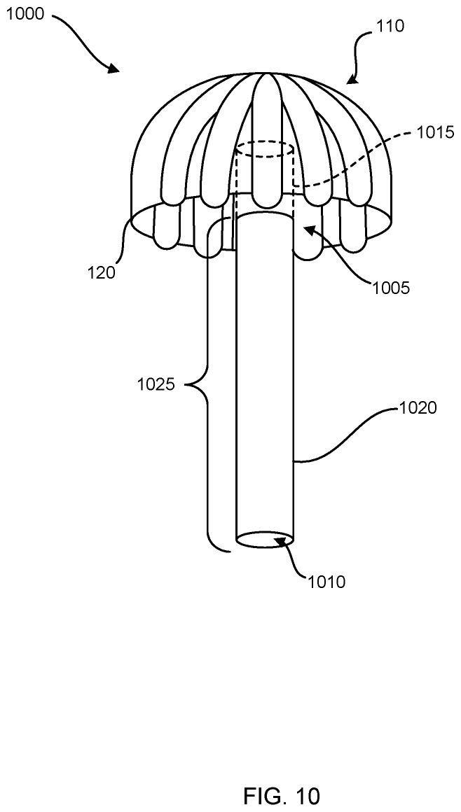

FIG. 10 illustrates a perspective view of another example of an S-bit 1000. Spherical bit 100 includes spherical portion 110 having edge 120. As shown, spherical portion 110 may be substantially hollow. In some embodiments, spherical portion 110 may be filled (not hollow). In some embodiments, body 1020 may include a cylindrical shaft 1025. However, shaft 1025 may be any suitable shape including having a square cross section, hexagonal cross section, or any other suitable shape. A diameter of the cylindrical shaft 1025 at both the first end 1005 and second end 1010 may be less than a diameter of spherical portion 110. In some embodiments, cylindrical shaft 1025 is any other diameter. In some embodiments, shaft 1025 may be coupled with spherical portion 110 using means 1015 and may be detachably or permanently coupled. In an example, shaft 1025 may be embodied in a motor shaft.

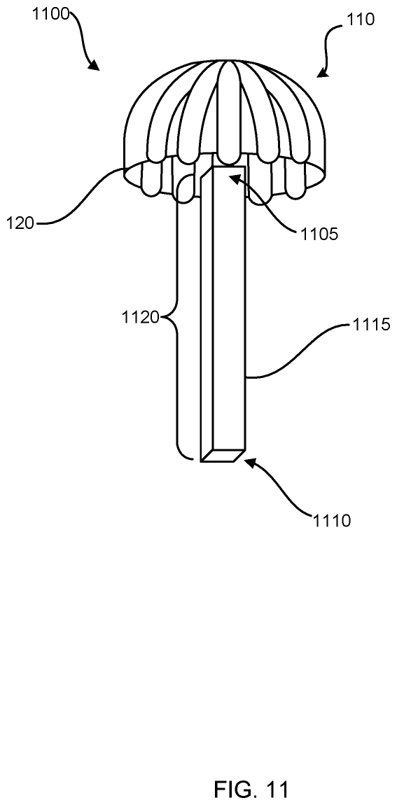

FIG. 11 illustrates a perspective view of another example of an S-bit 1100. As shown, spherical portion 110 may be substantially hollow. In some embodiments, spherical portion 110 may be filled (not hollow). In some embodiments, body 1115 may include shaft 1120 having a square or polygonal (e.g., rectangular or hexagonal) cross section. Any suitable shape including cylindrical may be used as shown in FIG. 10. An area of a cross section of shaft 1120 at both the first end 1105 and second end 1110 may be less than an area of a circle formed by edge 120 of spherical portion 110. In some embodiments, shaft 1120 may couple, detachably or permanently, to a means (not shown but substantially similar to means 1015 of FIG. 10) of spherical bit 1100. Shaft 1120 may couple at second end 1110 to a device or system capable of applying a torque to body 1115 to cause S-bit 1100 to rotate. In an example, shaft 1120 may be clamped (e.g., by a chuck, not shown) to a motor shaft.

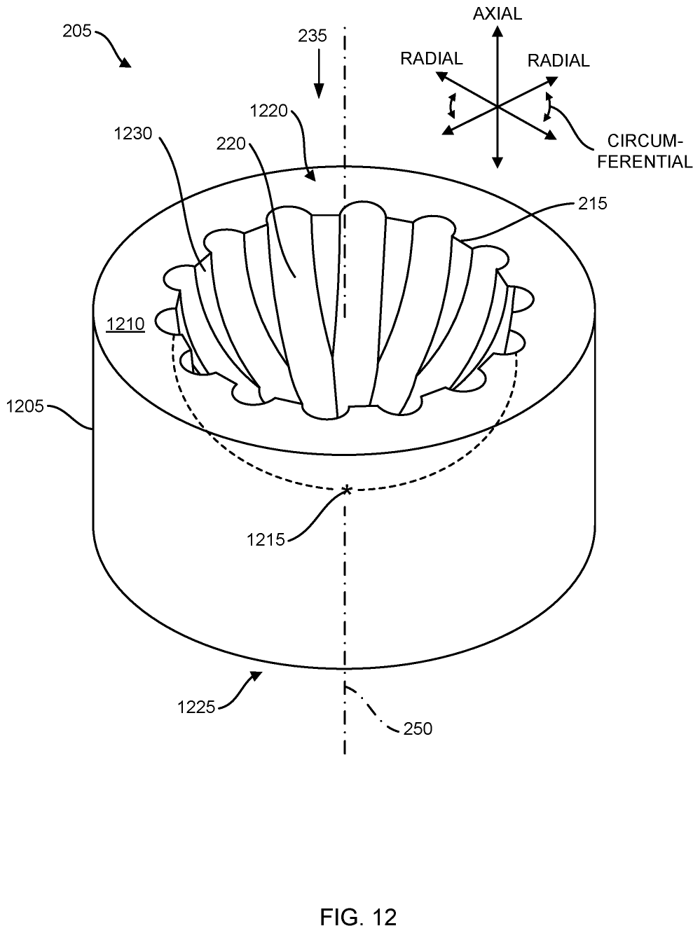

FIG. 12 illustrates a perspective view of receptacle end 205 of a fastening device 200 that may be rotated by embodiments of a spherical bit (e.g., spherical bit 100). Receptacle end 205 may include a body 1205. Fastening device 200 may extend axially along an axis 250 from a first end 1220 to a second end 1225. When aligned, axis 250 and axis 150 of the spherical bit 100 are the same. However, the shape and configuration of spherical bit 100 and receptacle 225 allow for misalignment of up to 24 degrees while still allowing spherical bit 100 and fastening device 200 to couple or mate.

The distal surface 1210 of receptacle end 205 may include receptacle 225. Receptacle 225 includes spherical void 235 having a spherical shape and a bottom center 1215. Spherical void 235 includes complementary (e.g., mating) structures into which the above-described structures the spherical portion of the spherical bit may be inserted in a male-female type connection scheme.

Spherical void 235 may be formed in body 1205 starting at the first end 1220 and extending inward toward the second end 1225. In some embodiments, spherical void 235 may be centered on axis 250 such that axis 250 extends through the bottom center 1215.

Body 1205 is shown as cylinder shaped, where the planes defined by the first end 1220 and the second end 1225 are circular. In other embodiments, body 1205 may have a polyhedron cross section shape, such as square or polygonal (e.g., rectangular, hexagonal, etc.).

Spherical void 235 may be formed by any suitable technique known, or to be known in the future, by persons having ordinary skill in the art. For instance, spherical void 235 may be formed by machining, molding, extruding, grinding, stamping, carving, and/or reductive manufacturing techniques, which may be selected according to the particular material(s) of construction involved.

Receptacle 225 further includes grooves 220 as described with respect to FIG. 2, where the grooves 220 extend from edge 215 to bottom center 1215. Grooves 220 correspond to teeth 115 of spherical bit 100, for example.

In some embodiments, receptacle end 205 may be coupled at the second end 1225 to a component (e.g., latch piece 325, fastening piece having threads 230, or a switching device such as circuit breaker 345) such that rotation of the receptacle end 205 and the component complete a desired action (e.g., opening or closing a fastener, latching or unlatching a fastener, turning the component on or off, or the like). The receptacle end 205 and the fastening end (e.g., fastening end 210) may be formed, coupled together, or otherwise manufactured using any suitable technique known, or to be known in the future, by persons having ordinary skill in the art. For instance, the receptacle 225 may be formed onto the first end 1220 of the receptacle end 205 and the receptacle end 205 may be coupled to the fastening end 210 by welding, cementing, screwing, and similar techniques. Alternatively, or additionally, receptacle end 205 may be added onto the fastening end by 3D printing, powder bed sintering, and similar additive manufacturing techniques, which may be selected according to the particular material(s) of construction involved. In yet another example, the entirety of fastening device 200 may be fabricated using an additive manufacturing technique.

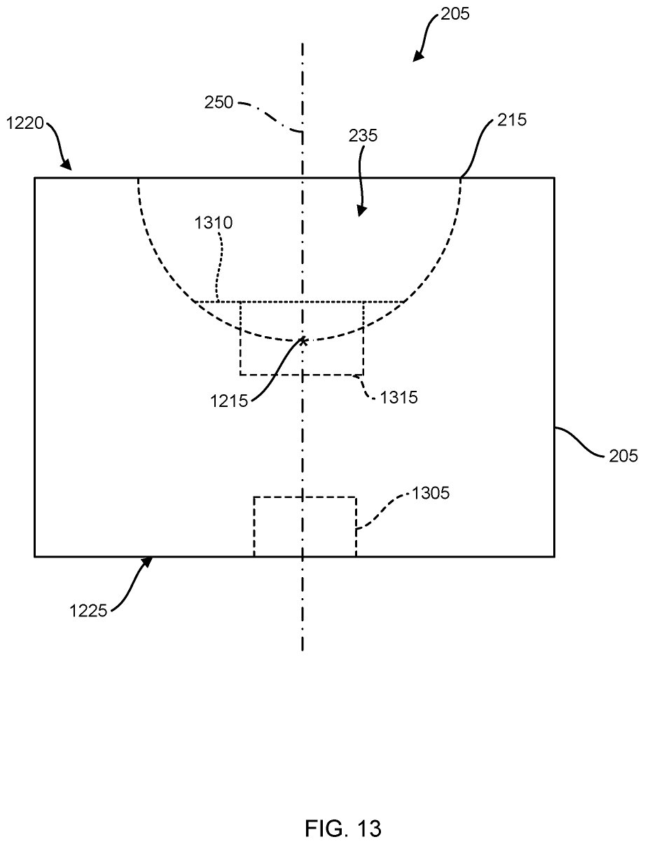

FIG. 13 illustrates a side view of receptacle end 205. In some embodiments, the device 200 may include one or more means 1305 for coupling the second end 1225 to another functional piece or component so that rotation of the device 200 by, for example, S-bit 100 rotates the piece. Non-limiting examples of functional pieces or components that may be coupled, or couplable, to device 200 via the means 1305 for coupling may include a shaft (which may include threads 230 for use as a fastener as in a screw or bolt), a bar or latch (e.g., latch piece 325 which may be used with a lock mechanism such as for a cabinet, or as an actuator for a circuit breaker), or any other suitable mechanism. Additional examples of such functional pieces or components, be they now known or as yet unknown, are expected to be readily recognized, appreciated, and practiced without undue experimentation by persons having ordinary skill in the art without departing from the scope and spirit of the present disclosure.

In some embodiments, means 1305 for coupling may include a cavity formed into receptacle end 205 starting at the second end 1225 and extending axially toward the first end 1220 into a portion of the receptacle end 205. In the example shown, the cavity of means 1305 for coupling may be cylindrical or polyhedron shaped for coupling and does not extend to spherical void 235. In other embodiments (not shown), means 1305 for coupling may extend through receptacle end 205 and open into spherical void 235 such that spherical void 235 includes an opening at the bottom center 1215. Means 1305 for coupling may be threaded or not threaded depending on the nature of the functional component or piece to be coupled to the second end 1225. In other examples, a surface of the second end 1225 may have a texture, coating, or material of constructure that facilitates cementing or welding a functional component or piece to second end 1225, either instead of, or in addition to, using the void-type means 1305 for coupling.

Spherical void 235 includes grooves 220 not seen in the side view of FIG. 13. As already discussed, grooves 220 may be disposed and spaced circumferentially on, and may extend into, and radially outward from, the spherical void 235. In other words, grooves 220 extend from bottom center 1215 to edge 215. Grooves 220 may include a first end positioned at, or proximate to, edge 215 and a second end positioned at or proximate to bottom center 1215. Radially inward-facing portions of the grooves 220 may define surfaces that touch teeth 115 of spherical bit 100 when coupled. Surfaces (shown in FIG. 12 as 1230) defined between the grooves 220 correspondingly touch grooves 125 of spherical bit 100 when coupled. These surfaces 1230 may be described as teeth 1230 of the receptacle end 205.

In some embodiments, at least a portion of the radially inward surface of grooves 220 may be convexly arcuate to correspond to teeth 115.

In some embodiments, teeth 1230 are positioned between grooves 220. Teeth 1230 may be disposed and spaced circumferentially on, and may extend radially inward from, spherical void 235 (e.g., from the spherical side toward the axis 250). Teeth 1230 may be formed and positioned to correspond with grooves 125 of spherical bit 100. Accordingly, teeth 1230 may taper and be shaped to couple with grooves 125. Similarly, grooves 220 may be tapered and shaped to couple with teeth 115 of spherical bit 100.

Design features of the receptacle 225 of fastening device 200 may provide advantageous practical and technical benefits to users such as facilitating mating fitting with a complementary rotatable bit (e.g., S-bit 100). For example, the shape and size of the spherical void 235 as well as the shape, size, and number of grooves 220 that correspond with teeth of the spherical bit enable the mating connection to facilitate fastening device 200 (and any components or pieces coupled to its second end 1225) being rotated under torque with some degree of axial misalignment as between the S-bit 100 and the rotatable device 200.

To these advantageous ends, in some embodiments, grooves 220 may be circumferentially disposed into the radially inward side of spherical void 235 with equidistant spacing between respective first ends of each groove 220 at edge 215. In other words, grooves 220 may have first ends equidistantly spaced about edge 215 of spherical void 235. In other embodiments a first end at edge 215 of at least one groove 220 may not have equidistant spacing with respect to a first end at edge 215 of at least one other groove 220. In some embodiments, grooves 220 may be tapered in a first end-to-second end direction. In other embodiments, grooves 220 may be tapered in a second end-to-first end direction.

In some embodiments, tapering of the grooves may correspond to teeth 505 as described with respect to FIG. 5 to allow coupling between fastening device 200 and spherical portion 500. As such, the bottom portion of spherical void 235 may include the optional at least partially arcuate or planar surface 1310. In such cases, spherical void 235 may be only partially hemispherical or spherical.

In some embodiments, a slot 1315 may be optionally included that may allow a standard flat-head screw driver to be inserted for rotating the fastening device 200. For example, a manual rotation may be required and may be more easily implemented with such a driver.

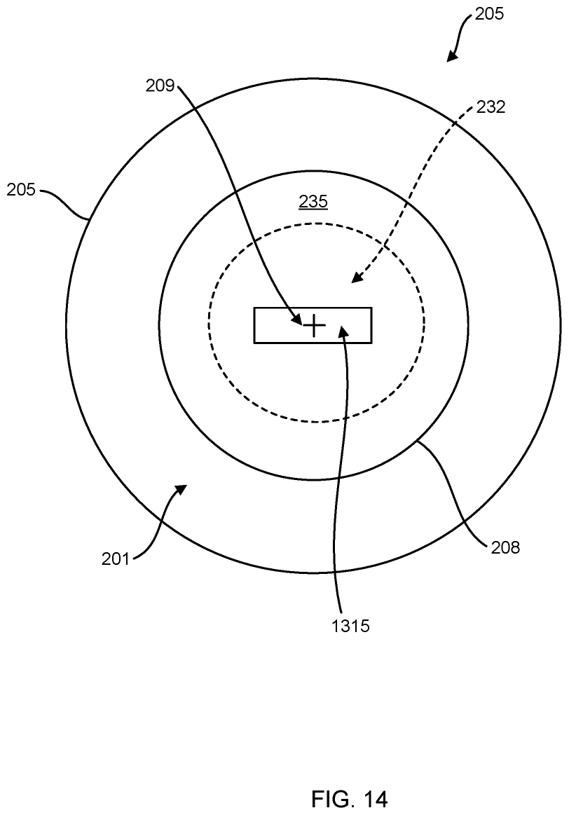

FIG. 14 illustrates a pan view of receptacle end 205. In some embodiments, slot 1315 may be formed into a bottom portion of spherical void 235. Slot 1315 may be a rectangular polyhedral so as to be capable of receiving the head of a flat head screwdriver, for example. Inclusion of slot 1315 in the bottom of spherical void 235 may be useful in cases where the mating S-bit 100 is unavailable and a need arises for the fastening device 200 to be rotated manually by hand using a flat head screwdriver. Likewise, in other embodiments, a radially outward surface of receptacle end 205 may include axially oriented and spaced ridges and/or grooves (not shown) to provide a suitable mating head and additional friction and ergonomic advantage for turning the fastening device 200 using one's hand or, alternatively, pliers or any other suitable tool. To similar ends, a square or hexagonal shaped receptacle end 205 may enable rotating device using a suitably sized wrench or socket in cases where S-bit 100 may be unavailable.

FIG. 15 is a block diagram of an example system 1500 including the S-bit 100 and the fastening device 200 for rotating by the S-bit 100 according to some embodiments of the disclosure. The features described with respect to receptacle 225 throughout the drawings and the features of the spherical portion of the spherical bit including spherical portion 110 and spherical portion 500 may be incorporated into system 1500. For example, and without limitation, in forming the mating connection between the S-bit 100 (e.g., “male”) and the fastening device 200 (e.g., “female”), a full alignment would entail an angle of zero degrees (0°) as between axis 150 and axis 250. In an example, automated machine 310 may need to spend time and electric power to perform very fine maneuvering at least of arm 315 to achieve the full alignment condition.

While it is certainly within the realm of possibility that automated machine 310 can achieve this full alignment, it may be advantageous for an operator of a facility to enable the mating connection between S-bit 100 and fastening device 200 without requiring the full alignment condition. For instance, being able to form the mating connection with a full alignment between axes 150 and 250 may save time and may save electrical power (e.g., for a battery onboard automated machine 310). Rotating S-bit 100 to thereby rotate fastening device 200 in the absence of full alignment between axes 150 and 250 may thus enable a longer operation time on the factory floor for automated machine 310. As a result, a greater number of unit operations per unit of time may be achieved in a facility using automated machine 310 by practicing the embodiments of the disclosure. In some embodiments, a maximum angle 1510 of, for example, 24 degrees as between axes 150 and 250 may be present and still enable the mating connection between spherical portion 110 of S-bit 100 and receptacle 225 of device 200. In other words, even with up to 24 degrees of axial misalignment in any direction between axes 150 and 250, the S-bit 100 being rotated by driver 330 may still rotate fastening device 200 and any component or piece (e.g., latch 325 or shaft having threads 230) attached to the receptacle end 205 of device 200. With the maximum angle of 24 degrees as between axes 150 and 250 being permitted by the disclosed embodiments, a full range of possible misalignment is thus an angle 1515 of 48 degrees (2*24°). While the two-dimensional image shown in FIG. 15 suggests that the degree of misalignment may be to the left or right, in fact the misalignment may be in any direction from the axis 250.

FIG. 16 illustrates an exemplary computing device or controller 1600. Automated machine 310 may include controller 1600 for controlling arm 315 and other features of automated machine 310. In some embodiments, controller 1600 may be external to automated machine 310 and be coupled to control circuitry within automated machine 310 to cause automated machine 310 to perform the functions discussed with respect to FIG. 3.

Controller 1600 is representative of any system or collection of systems in which processes performed by automated machine 310 may be implemented. Controller 1600 may be implemented as a single apparatus, system, or device or may be implemented in a distributed manner as multiple apparatuses, systems, or devices. Controller 1600 includes, but is not limited to, processing system 1620, storage system 1605, software 1610, communication interface system 1615, and user interface system 1625 (optional). Processing system 1620 is operatively coupled with storage system 1605, communication interface system 1615, and user interface system 1625 via, for example, a bus.

Processing system 1620 loads and executes software 1610 from storage system 1605. Software 1610 includes and implements automation processing instructions 1630, which is representative of the processes performed by automation machine 310. For example, automation processing instructions 1630 may include instructions to move arm 315 to align spherical bit 100 with fastening device 200 as well as any other instructions and tasks performed by automation machine 310. When executed by processing system 1620, software 1610 directs processing system 1620 to operate as described herein for at least the various processes, operational scenarios, and sequences discussed in the foregoing implementations. The processing system 1620 may, for example, provide signals to communication interface system 1615 that may include the input/output necessary to control arm 315. Controller 1600 may optionally include additional devices, features, or functionality not discussed for purposes of brevity.

Processing system 1620 may comprise a micro-processor and other circuitry that retrieves and executes software 1610 from storage system 1605. Processing system 1620 may be implemented within a single processing device but may also be distributed across multiple processing devices or sub-systems that cooperate in executing program instructions. Examples of processing system 1620 include general purpose central processing units, graphical processing units, application specific processors, and logic devices, as well as any other type of processing device, combinations, or variations thereof.

Storage system 1605 may comprise any computer readable storage media readable by processing system 1620 and capable of storing software 1610. Storage system 1605 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1605 may also include computer readable communication media over which at least some of software 1610 may be communicated internally or externally. Storage system 1605 may be implemented as a single storage device but may also be implemented across multiple storage devices or sub-systems co-located or distributed relative to each other. Storage system 1605 may comprise additional elements, such as a controller, capable of communicating with processing system 1620 or possibly other systems.

Software 1610 (including automation processing instructions 1630) may be implemented in program instructions and among other functions may, when executed by processing system 1620, direct processing system 1620 to operate as described with respect to the various operational scenarios, sequences, and processes illustrated herein. For example, software 1610 may include program instructions for implementing the automation processes as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1610 may include additional processes, programs, or components, such as operating system software, virtualization software, or other application software. Software 1610 may also comprise firmware or some other form of machine-readable processing instructions executable by processing system 1620.

In general, software 1610 may, when loaded into processing system 1620 and executed, transform a suitable apparatus, system, or device (of which controller 1600 is representative) overall from a general-purpose computing system into a special-purpose computing system customized to support automation processing. Indeed, encoding software 1610 on storage system 1605 may transform the physical structure of storage system 1605. The specific transformation of the physical structure may depend on various factors in different implementations of this description. Examples of such factors may include, but are not limited to, the technology used to implement the storage media of storage system 1605 and whether the computer-storage media are characterized as primary or secondary, etc.

For example, if the computer readable storage media are implemented as semiconductor-based memory, software 1610 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1615 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here. Further, communication interface system 1615 may include input/output connections to components of automated machine 310 including arm 315, driver 330, and the like. Accordingly, execution of automation processing instructions 1630 by processing system 1620 may cause communication interface system 1615 to cause arm 315 and driver 330 to move, align, rotate, and the like.

Communication between controller 1600 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples provided herein are described in the context of particular embodiments of devices and systems for enabling rotation of a device by an S-bit in the absence of full axial alignment, it should be understood that the particular systems and methods described herein are not limited to such embodiments and may apply to a variety of other extension implementations and their associated devices, systems and methods. As will be appreciated by persons having ordinary skill in the art, aspects of the present invention may be embodied as a system, method, and other configurable systems.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “optionally,” and the like generally mean the particular feature, structure, or characteristic following the phrase is included in at least one implementation of the present technology and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while a specific number of teeth and grooves are shown in the figures for each S-bit, other numbers of teeth and grooves are contemplated without departing from the spirit of this disclosure. Further any specific numbers noted herein are only examples, and alternative implementations may employ differing values or ranges.

The teachings of the technology provided herein can be applied to other systems, not necessarily the system described above. For example, other industrial automation systems may employ the use of the S-bit and fastener described above. Further, any rotatable device may implement the receptacle described, whether or not a fastening device. For example, a switch, circuit breaker, or other type of component that may rotate to turn on or off may implement the receptacle for rotating by the S-bit. Further, the elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. Any claims intended to be treated under 35 U.S.C. § 112 (f) may begin with the words “means for” but use of the term “for” in any other context is not intended to invoke treatment under 35 U.S.C. § 112 (f). Accordingly, the applicant reserves the right to pursue additional claims after filing this application to pursue such additional claim forms, in either this application or in a continuing application.

What is claimed is:

1. An industrial automation system comprising:
a robotic arm coupled to a controller and a driver;
the driver coupled to a spherical bit;
the controller comprising instructions that, upon execution by one or more processors of the controller, cause:
the robotic arm to autonomously move to align and couple the spherical bit with a receptacle of a fastening device, and
the driver to spin on an axis to rotate the fastening device; and
the spherical bit, comprising a shaft end and a coupling end, wherein:
the shaft end is coupled to the driver,
the coupling end comprises an at least partially spherical portion that couples with the receptacle of the fastening device,
the at least partially spherical portion comprises a plurality of teeth disposed circumferentially on the at least partially spherical portion, and
each of the plurality of teeth comprises:
a first end proximate to a tip of the at least partially spherical portion; and
a second end proximate to an edge of the at least partially spherical portion.

2. The industrial automation system of claim 1, further comprising the fastening device, wherein the fastening device comprises a body having a receptacle end and a fastening end, and wherein:
the receptacle end comprises the receptacle, the receptacle comprising an at least partially spherical void formed in the body at the receptacle end,
the at least partially spherical void comprises a plurality of grooves circumferentially spaced on and extending radially into the at least partially spherical void such that when coupled, each of the plurality of teeth of the spherical bit fit into one of the plurality of grooves of the fastening device.

3. The industrial automation system of claim 2, further comprising:
a motor control cabinet (MCC), the MCC comprising a door, wherein the fastening device fastens the door.

4. The industrial automation system of claim 1, wherein the second end of the plurality of teeth are equidistantly spaced about the edge of the at least partially spherical portion.

5. The industrial automation system of claim 1, wherein each of the plurality of teeth is tapered to a point at the first end.

6. The industrial automation system of claim 5, wherein:
the tip of the at least partially spherical portion comprises an arcuate surface including the point of the first end of each of the plurality of teeth, and
a distance from a center point of the at least partially spherical portion to the point and any other point on the arcuate surface is less than a radius of curvature of the at least partially spherical portion.

7. The industrial automation system of claim 1, wherein the at least partially spherical portion of the spherical bit further comprises a plurality of grooves positioned between each of the plurality of teeth and extending radially into the at least partially spherical portion.

8. The industrial automation system of claim 7, wherein each of the plurality of grooves is tapered in a direction of the edge toward the tip.

9. The industrial automation system of claim 7, wherein at least a portion of a surface of each of the plurality of grooves is convexly arcuate.

10. The industrial automation system of claim 1, wherein a radius of curvature of the at least partially spherical portion allows for misalignment of up to twenty-four (24) degrees off an axis of the fastening device.

11. A spherical bit for rotating a fastening device, the spherical bit comprising a coupling end and a shaft end, wherein:
the spherical bit extends along an axis from the coupling end to the shaft end,
the coupling end comprises an at least partially spherical portion centered on the axis such that the axis extends through a tip of the at least partially spherical portion,
the at least partially spherical portion comprises a plurality of teeth disposed circumferentially on the at least partially spherical portion, and
each of the plurality of teeth comprises:
a first end proximate to the tip of the at least partially spherical portion; and
a second end proximate to an edge of the at least partially spherical portion.

12. The spherical bit of claim 11, wherein the second end of the plurality of teeth are equidistantly spaced about the edge of the at least partially spherical portion.

13. The spherical bit of claim 11, wherein at least a portion of a radially outward surface of the plurality of teeth is concavely arcuate.

14. The spherical bit of claim 11, wherein each of the plurality of teeth is tapered to a point at the first end.

15. The spherical bit of claim 14, wherein:
the tip of the at least partially spherical portion comprises an arcuate surface including the point of the first end of each of the plurality of teeth, and
a distance from a center point of the at least partially spherical portion to the point and any other point on the arcuate surface is less than a radius of curvature of the at least partially spherical portion.

16. The spherical bit of claim 11, wherein the at least partially spherical portion of the spherical bit further comprises a plurality of grooves positioned between each of the plurality of teeth and extending radially into the at least partially spherical portion.

17. The spherical bit of claim 16, wherein the plurality of grooves are tapered in a direction of the edge toward the tip.

18. The spherical bit of claim 16, wherein at least a portion of a surface of the plurality of grooves is convexly arcuate.

19. A fastening device comprising a body having a fastening end and a receptacle end, wherein:
the fastening device extends along an axis from the fastening end to the receptacle end,
the receptacle end comprises a receptacle, the receptacle comprising an at least partially spherical void formed in the body at the receptacle end,
the at least partially spherical void comprises a plurality of grooves circumferentially spaced on and extending radially into the at least partially spherical void, and
each of the plurality of grooves comprises:
a first end proximate to an edge of the at least partially spherical void; and
a second end proximate to a bottom center of the at least partially spherical void.

20. The fastening device of claim 19, wherein the first end of the plurality of grooves are equidistantly spaced about the edge of the at least partially spherical void.
